(19) United States
(12) Patent Application Publication
(10) Pub. No.: US 2026/0024925 A1
(43) Pub. Date: Jan. 22, 2026

(54) CONDUCTOR TERMINAL

(71) Applicant: WAGO Verwaltungsgesellschaft mbH, Minden (DE)

(72) Inventor: Michael MEYER, Wiedensahl (DE)

(73) Assignee: WAGO Verwaltungsgesellschaft mbH, Minden (DE)

(21) Appl. No.: 19/273,235

(22) Filed: Jul. 18, 2025

(30) Foreign Application Priority Data
Jul. 19, 2024 (DE) 20 2024 104 042.2

(51) Int. Cl. H01R 4/48

(52) U.S. Cl. CPC H01R 4/4828; H01R 4/48185

(57) ABSTRACT

A conductor terminal having an insulating material housing, a spring force clamping connection for connecting an electrical conductor in the insulating material housing and an actuating element. The spring force clamping connection has a busbar and a clamping spring. The clamping spring comprises a clamping leg having a clamping edge for clamping an electrical conductor to a contact section of the busbar, an attachment leg, which is in contact with the busbar and supports the clamping spring on the busbar, and a resilient bend, which connects the attachment leg with the clamping leg. In addition, the insulating material housing has a conductor insertion channel leading to the contact section and an actuating channel, which is movably mounted in the actuation channel and is set up to exert force on the clamping leg in order to displace the clamping leg against the force of the clamping spring into a hold-open position.

This nonprovisional application claims priority under 35 U.S.C. § 119 (a) to German Patent Application No. 20 2024 104 042.2, which was filed in Germany on Jul. 19, 2024, and which is herein incorporated by reference.

### FIELD OF THE INVENTION

The invention relates to a conductor terminal comprising an insulating material housing, a spring force clamping connection for connecting an electrical conductor in the insulating material housing, and an actuating element, wherein the spring force clamping connection has a busbar and a clamping spring, wherein the clamping spring comprises a clamping leg with a clamping edge for clamping an electrical conductor to a contact section of the busbar, an attachment leg which is in contact with the busbar and supports the clamping spring on the busbar, and a resilient bend connecting the attachment leg to the clamping leg, wherein the insulating material housing has a conductor insertion channel leading to the contact section of the busbar and an actuating channel, and wherein the actuating element in the actuating channel is movably mounted and is set up for exerting force on the clamping leg in order to displace the clamping leg against the force of the clamping spring in the direction of the attachment leg in a hold-open position.

### DESCRIPTION OF THE BACKGROUND ART

Spring force clamping connections are used to clamp electrical conductors to a clamping point formed between the clamping leg of a clamping spring and a busbar. To clamp the electrical conductor, the clamping spring can be pushed away from the busbar against the force of the clamping spring when connected directly by the electrical conductor. This is possible for rigid conductors, but not for multi-wire conductors or stranded conductors.

There is a need for the clamping of electrical conductors to provide a spring force clamping connection in a self-retaining position in a hold-open position. It is often desired that conductor terminals with an open spring force clamping connection are delivered from the factory.

DE 20 2011 051 466 U1 discloses a clamping spring for a terminal with a clamping leg that transitions into a first clamping device (i.e., a resilient bend) to which a base arm is connected and downstream of a second clamping device, a latching arm. The latching arm has protrusions protruding from the plane of the latching arm, which form a stop for the clamping edge of the open clamping leg when the clamping leg is displaced against the spring force towards the base arm.

EP 2 466 689 B1 discloses a clamping contact for the electrical connection of conductors with a clamping point comprising a contact field for the close fit of the electrical conductor and a spring leg, the free end of which holds the electrical conductor between itself and the contact field when the clamping contact is closed. The clamping contact has a separate triggering lever, which is arranged in the trajectory of the electrical conductor and is connected to the spring leg in an active connection that keeps the spring leg in a hold-open position.

WO 2021/105280 A1, which corresponds to US 2022/0416449, discloses a direct plug-in terminal for connecting an electrical conductor with a busbar and a clamping spring acting as a compression spring, as well as a retaining spring for latching the clamping spring in a hold-open position.

### SUMMARY OF THE INVENTION

It is therefore an object of the present invention to provide an improved spring force clamping connection and a conductor terminal having such a spring force clamping connection.

It is proposed, in an example, that an actuating section protrudes from the side of the clamping leg and that the actuating element extends past a side edge of the clamping leg to the actuating section and is designed to exert force on the actuating section.

With the help of the at least one actuating section that protrudes laterally from the clamping leg, the actuating element can be guided past the side edge of the clamping leg to the actuating section in a space-saving manner, so that no installation space is required between the clamping leg and the plugged-in, clamped electrical conductor to accommodate sections of the actuating element.

The spring force clamping connection can be self-retaining in a hold-open position. This allows for the spring force clamping connection to be delivered, for example, with the clamping point open and released by inserting an electrical conductor, so that the clamping leg clamps the inserted electrical conductor to the contact section of the busbar. For this purpose, for example, a retaining arm may be connected to the attachment leg, which has a latching contour designed to latch the clamping leg, which is deflected against the spring force of the clamping spring towards the attachment leg, in a hold-open position. However, other examples are also conceivable for the formation of the latching contour, which can be formed on a separate hold-open element, for example.

Due to the design of the invention, the latching of the clamping leg can be done in a compact manner without additional components with the retaining arm protruding from the attachment leg, which has a latching contour interacting with the clamping leg.

The actuating element may have one actuating element head and two actuating element bars protruding from the actuating element head at a distance from each other. Actuating sections may protrude from the clamping leg on both sides of opposing side edges of the clamping leg, wherein the actuating bars each extend past one side edge of the clamping leg to the corresponding actuating section. This enables compact, symmetrical actuation of the clamping leg by the actuating element.

For this purpose, the actuating element can be designed as an actuating pusher that can be moved linearly in one direction of operation in the actuation channel. However, it is also conceivable to have a variant with a swivelling or floating actuating element with a swivel-slide movement, which is guided past a side edge of the clamping leg with at least one actuating bar and is designed to exert force on the associated actuating section.

The actuating element can have a stop contour. The insulating material housing and/or the clamping spring may have a counter-stop contour, wherein the stop contour and the counter-stop contour form a stop securing the actuating element in the actuation channel. This allows for the actuating element to be held in an end position on the insulating material housing and/or the clamping spring by means of a positive fit, for example to secure the actuating element from falling out of the insulating material housing, including when it is not actuated.

In order to indicate the hold-open state of the clamping spring, in which the clamping leg is latched on the retaining arm in the hold-open position, the actuating element can optionally be pressed against a wall of the actuation channel of the insulating material housing with at least one actuating section in order to remain frictionally in the depressed hold-open position. This means that the user can see the latched hold-open position based on the position of the actuating element.

The retaining arm can be spring-elastic in the area of the snap-in contour. This makes it possible to ensure that the latching contour springs back into the latching position after the clamping leg has been released, in which a clamping leg that has been displaced to the attachment leg in the hold-open position can be latched in the latching contour.

The latching contour of the retaining arm can be formed by a retaining flap protruding from the retaining arm or by a front edge on the retaining arm.

The retaining arm can be bent away from the clamping leg adjacent to the latching contour. The retaining arm may be tapered from the bend to the attachment leg, with a front edge forming the latching contour at the transition of the side edge of the retaining arm to the widened section of the bend protruding laterally from it. The bending may result in a stiffening of the retaining arm in the area of the latching contour. The at least one front edge resulting from the taper in the transition of the bend forms a stable latching contour without additional elaborate reshaping in production. This is easy to produce, as it is hardly susceptible to tolerances. The arrangement of the latching contour in the area of the bend is very stable and insensitive to external influences such as vibration.

On both sides of the opposing side edges of the tapered section of the retaining arm, widened sections of the bend may protrude laterally on the retaining arm and form a latching contour with their front edges. This achieves a symmetrical latching of the clamping leg to the retaining arm. The front edges or the widened sections may be arranged in the transition of the retaining arm to a connecting section, which will be explained in more detail below, which connects the retaining arm to a triggering section of a triggering piece.

A latching tab may protrude from the clamping leg towards the retaining arm and may be set up to latch in the latching contour in the hold-open position of the clamping leg. The latching tab can be cut free at the lateral edge region of the clamping leg and bent with its free end out of the plane of the clamping leg towards the retaining arm. The free end area of the clamping leg can be correspondingly narrower or merge into a wider end section. The clamping edge for clamping the electrical conductor is preferably formed by the front edge of the free end of the clamping leg.

A triggering piece may be connected to the retaining arm, in particular on the side facing away from the attachment leg, which extends with a triggering section into the alignment of the conductor insertion channel and is designed to be deflected by an electrical conductor inserted into the conductor insertion channel for clamping to the busbar and to release the latching contour for the triggering of the clamping leg latched in the hold-open position. With this triggering piece, the connected retaining arm can be shifted to move the latching contour away from the clamping leg and triggering the clamping leg. The clamping leg thus released can then move towards the contact section of the busbar by the force of the clamping spring in order to clamp the inserted electrical conductor that has impinged upon the triggering section and has displaced the retaining arm.

The triggering piece can form a tapered free end of the clamping spring. This allows for the triggering piece to move unhindered by the triggering force of an electrical conductor. Alternatively, it is also conceivable that the free end of the triggering piece is mounted on the insulating material housing, for example.

The insulating material housing may have a run-on slope for guiding an electrical conductor to the triggering section, wherein the run-on slope is located between the alignment of the conductor insertion channel and a connecting section of the triggering piece extending from the retaining arm to the triggering section. This has the advantage that unintentional premature releasing of the clamping leg by the electrical conductor imping upon the connecting section is prevented. The run-on slope located in a conductor collection pocket of the insulating material housing stands in the way of an electrical conductor inserted into the conductor collection pocket as it moves towards the connecting section. Instead, the electrical conductor is guided to the triggering section and is plugged in far enough to be clamped when the electrical conductor acts on the triggering section for the disengagement of the clamping leg.

The busbar can have a conductor feed-through opening, and the clamping spring can protrude into the conductor feed-through opening with its attachment leg and clamping leg. This allows for a narrow and compact design of the conductor terminal to be realized. The conductor feed-through opening can be formed by the end wall on which the attachment leg is mounted, a contact tab opposite the end wall, which protrudes from the plane of the conductor feed-through opening in the direction of the conductor collection pocket or the triggering section located therein and forms the contact section, and a side wall connecting the end wall with the contact tab. It is conceivable that there are two side walls spaced from each other, which extend parallel to each other between the end wall and the contact tab. At least one of the side walls can be designed as a side bridge. However, it is also conceivable that at least one of the side walls is designed as a side wall protruding from the plane of the conductor feed-through opening. This allows for high busbar stability and current-carrying capacity to be achieved. Optionally, however, it is also conceivable that the conductor feed-through opening has a collar circumferentially on the underside of the busbar, which is turned away from the top of the busbar facing the resilient bend of the clamping spring, with a collar wall forming the contact section. The collar wall forming the contact section is preferably flared at an angle to provide a defined contact surface for clamping the electrical conductor.

Below the busbar, the retaining arm can be bent away from the clamping leg on the upper side, which faces the resilient bend of the clamping spring, of the underside facing away from the busbar.

The clamping spring may be mounted with its attachment leg on an end wall bordering the conductor feed-through opening.

The attachment leg may taper with its section protruding into the conductor feed-through opening and may be supported on the busbar with bearing sections forming the transition of the taper to the wider section extending towards the resilient bend and protruding laterally from the tapered section. This means that the clamping spring is stably mounted on the busbar with a self-supporting system in which the clamping force acting on a clamped electrical conductor and the opposing force acting on the attachment leg are absorbed via the busbar. The support through the front edges of the bearing section in the transition of the wider area to the narrower area of the attachment leg protruding into the conductor feed-through opening is used to support the clamping spring on the busbar in order to positively attach the clamping spring to the busbar in the direction of insertion of the conductor.

The at least one actuating section can point with its free end in the direction of the attachment leg. If there are several actuating sections, each of them may point with their free end in the direction of the attachment leg. This allows for a compact, small-scale design of the clamping spring's actuation mechanism.

For example, the conductor terminal can have several spring force clamping connections with each actuating element in the insulating material housing. The spring force clamping connections can each have their own busbar. However, it is also conceivable that two or more clamping springs interact with a common busbar, so that several spring force clamping connections are formed, each consisting of one clamping spring and one busbar section of a common busbar.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a conductor terminal;

FIG. 2 is a side view of the conductor terminal from FIG. 1 in the unlatched clamping position;

FIG. 3 is a side view of the conductor terminal from FIG. 1 in the latched hold-open position;

FIG. 4 is a side section view of the conductor terminal from FIG. 2 in the unlatched clamping position;

FIG. 5 is a side view of the spring force clamping connection with actuating element in the unlatched clamping position;

FIG. 6 is a side view of the clamping spring with actuating element in the unlatched clamping position;

FIG. 7 is a rear view of the clamping spring with actuating element in the unlatched clamping position;

FIG. 8 is a perspective front view of the clamping spring with actuating element in the latched hold-open position;

FIG. 9 is a perspective rear view of the clamping spring with actuating element in the latched hold-open position;

FIG. 10 is a perspective front view of the spring force clamping connection with actuating element in the latched hold-open position;

FIG. 11 is a side view of the spring force clamping connection with actuating element in the latched hold-open position and the cutting line A-A;

FIG. 12 is a front view of the clamping spring with actuating element in section A-A in the unlatched clamping position;

FIG. 13 is a front view of the spring force clamping connection with actuating element in section A-A in the latched hold-open position;

FIG. 14 is a top view of the conductor terminal; and

FIG. 15 is a top view of the spring force clamping connection with actuating element.

### DETAILED DESCRIPTION

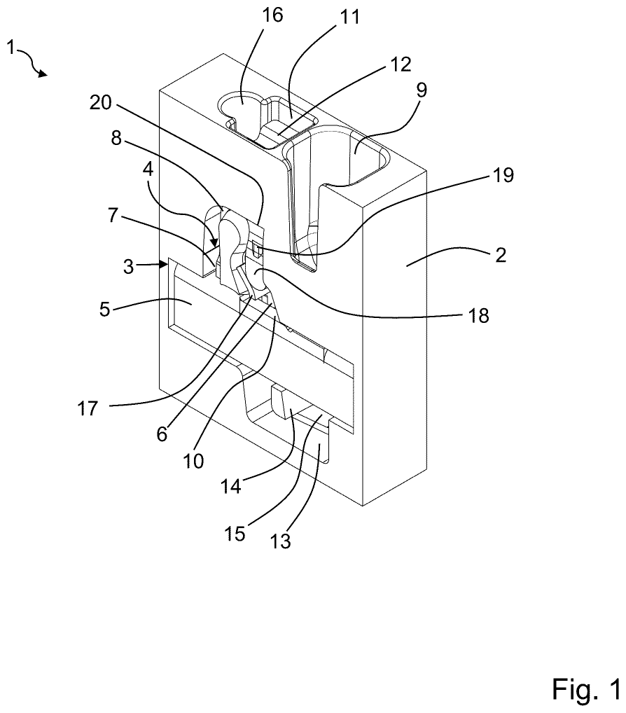

FIG. 1 shows a perspective view of a conductor terminal 1.

The conductor terminal 1 has an insulating material housing 2, in which a spring force clamping connection 3 is installed. As an alternative to the example shown, it is equally conceivable that several spring force clamping connections 3 are installed next to each other in different line-up directions in the insulating material housing 2.

The spring force clamping connection 3 has a clamping spring 4 and a busbar 5. The clamping spring 4 is designed for clamping an electrical conductor to a contact section of the busbar 5. As shown, it can be formed as a U-shaped bent torsion spring. The clamping spring 4 has a clamping leg 6, an attachment leg 7, which rests on the busbar 5 and supports the clamping spring 4 on the busbar 5, and a resilient bend 8, which connects the attachment leg 7 with the clamping leg 6.

The insulating material housing 2 has a conductor insertion channel 9, which leads to a conductor feed-through opening 10 in a busbar 5 of the spring force clamping connection 3. In addition to the conductor insertion channel 9, an actuation channel 11 is inserted into the insulating material housing 2. In the actuation channel 11, an actuating element 12 is movably mounted. As an example, an actuating lever movably mounted in the actuation channel 11 is shown as actuating element 12. However, swivelling actuating levers, floating actuating elements with a swivel-slide movement and the like are also conceivable.

Adjacent to the underside of the busbar 5, which is diametrically opposed to the conductor insertion channel 9, there is a conductor collection pocket 13. The conductor insertion channel 9 and the conductor feed-through opening 10 of the busbar 5 end in the conductor collection pocket 13, wherein the alignment of the conductor insertion channel 9 is directed into the conductor collection pocket 13. This way, an electrical conductor inserted into the conductor insertion channel 9 enters the conductor collection pocket 13. The insulating material housing 2 has a run-up slope 14 protruding from a side wall into the conductor collection pocket 13 for guiding the electrical conductor to a triggering section 15 of a triggering piece connected to the attachment leg 7.

The actuation channel 11 has a trough-shaped contour on the side wall facing away from the conductor insertion channel 9, so that a test opening 16 remains free between the actuating element 12 and the boundary wall of the trough-shaped contour, which opens towards the resilient bend 8.

It can be seen that an actuating section 17 in the form of a material flap extends laterally from the clamping leg 6. The actuating element 12 has an actuating bar 18 extending partly laterally past the clamping leg 6 and resilient bend, which acts upon the actuating section 17 with a curved end face, for example with a circular arc-shaped contour.

The actuating element 12 may also optionally have a stop contour 19 on an outer wall of the actuating element 12, for example the actuating bar 18 as shown. The insulating material housing 2 has a counter-stop contour 20, for example in the form of an upper end wall of a lateral clearance merging into the actuation channel 11. The stop contour 19 and the counter-stop contour 20 are designed and aligned with each other in such a way that they form a stop that secures the actuating element 12 in the actuation channel 11 from falling out.

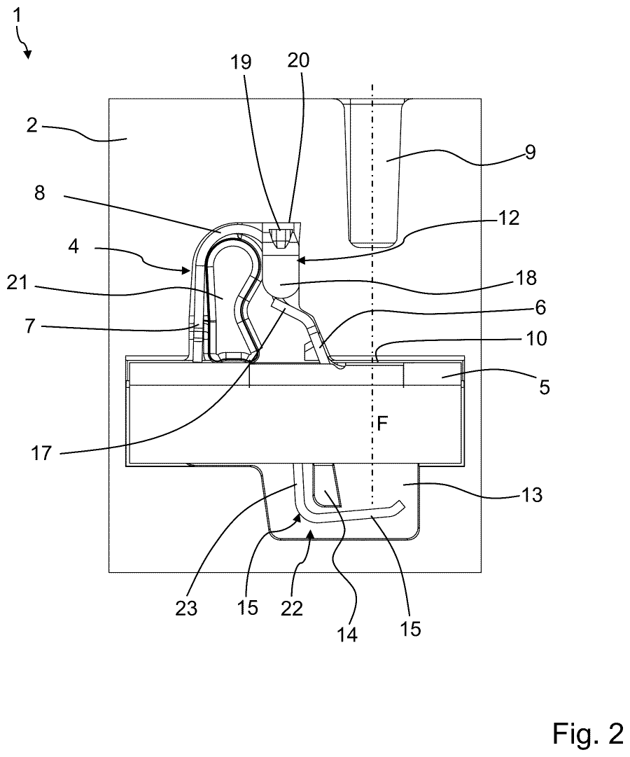

FIG. 2 shows a side view of the conductor terminal 1 from FIG. 1 in the unlatched clamping position.

It can be seen that the clamping leg 6 extending from the resilient bend 8 into the conductor feed-through opening 10 obliquely protrudes into the alignment of the conductor insertion channel 9. In addition to the attachment leg 7, there is a bearing pin 21 on which the resilient bend 8 is supported and which is located between the clamping leg 6 and the attachment leg 7.

It is also clear that the clamping spring 4 has a triggering piece 22, which has a horizontally aligned triggering section 15 aligned almost parallel to the upper level of the busbar 5, i.e., the plane spanned by the conductor feed-through opening 10, which stands in the alignment F of the conductor insertion channel 9, indicated by a dotted line. From the triggering section 15, a connecting section 23 is bent towards the busbar 5, so that the run-on slope 14 is positioned between the alignment F and the connecting section 23. This keeps an electrical conductor inserted into the conductor insertion channel 9 away from the connection section 23 and thus prevents undesirable premature disengagement of the clamping spring 4.

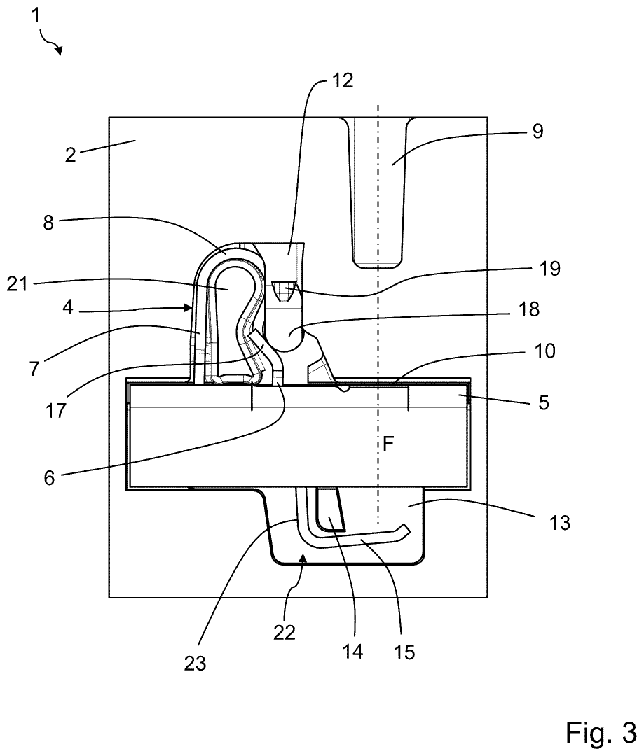

FIG. 3 shows a side view of the conductor terminal 1 from FIG. 1 in the latched hold-open position.

It becomes clear that the actuating element 12 is now displaced further into the actuation channel 11 towards the busbar 5 and, with its curved free end face of its actuating element bar 18, displaces the clamping leg 6 towards the attachment leg 7 by means of a compressive force on the laterally protruding actuating section 17. The clamping leg 6 thus emerges from the alignment F of the conductor insertion channel 9 and triggers the clamping point for clamping an electrical conductor.

It can also be seen here that the contact point of the curved end face of the actuation bar 18 at the actuating section 18 of the clamping leg 6 has been shifted from the position at the free end of the actuating section 17 (see FIG. 2) in the illustration of FIG. 3 to the free end of the clamping leg 6, or to the connection point of the actuating section 17 to the clamping leg 6.

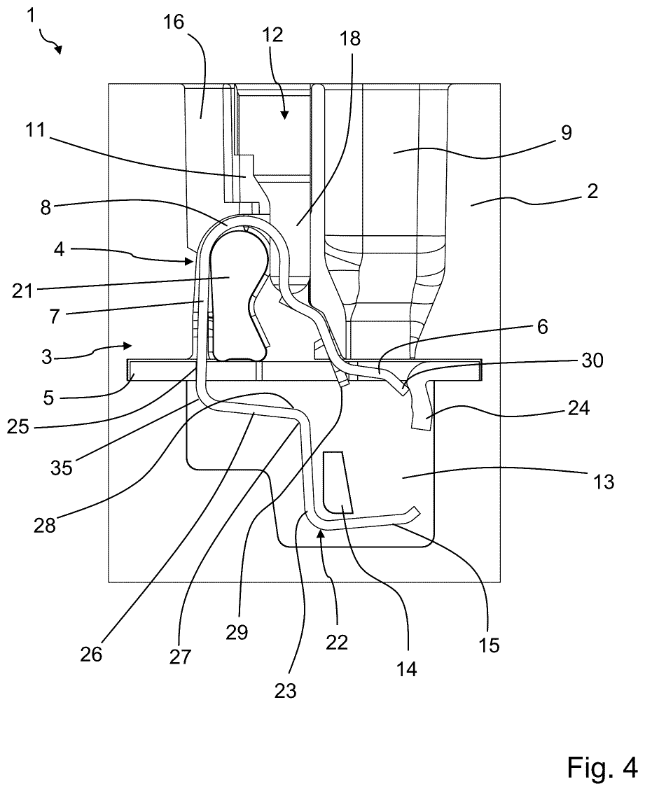

FIG. 4 shows a side-sectional view of the conductor terminal 1 from FIG. 2 in the unlatched clamping position.

From the conductor feed-through opening 10 of the busbar 5, a contact section 24 protrudes at one end face of the conductor feed-through opening 10 in the direction of the conductor collection pocket 13. The attachment leg 7 rests on the end face opposite the contact section 24 on an end wall 25 and is supported by a widened section adjacent to the end wall 25 on the upper side of the busbar 5. A retaining arm 26 is connected to the attachment leg 7, which extends to the contact section 24 on the underside of the busbar 5 opposite the resilient bend 8. From the retaining arm 26, the triggering piece 22 with its connecting section 23 is bent away from the busbar 5 or from the clamping leg 7 with a bend 27. In the area of the bend 27, the retaining arm 26 has a latching contour 28, which is formed in the hold-open position with a latching tab 29 of the clamping leg 6 protruding from the plane of the clamping leg 6, e.g., in a bend.

It can be seen that the clamping leg 6 has a clamping edge 30 at its free end, which clamping edge rests in the clamping position without an intermediate electrical conductor at the contact section 24. The clamping edge 30, together with the contact section 24, forms a clamping point to clamp the electrical conductor.

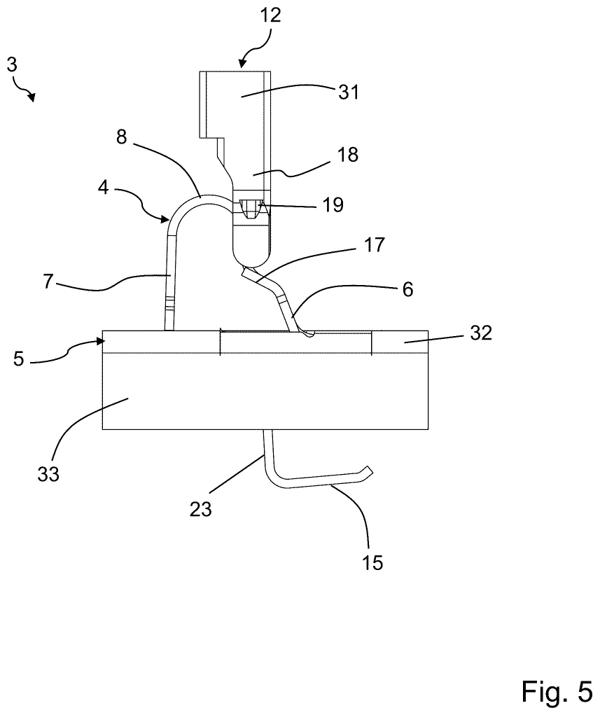

FIG. 5 shows a side view of the spring force clamping connection 3 with the actuating element 12 in the unlatched clamping position.

It becomes clear that an actuating section 17 protrudes from a side edge of the clamping leg 6, there is, which section may be partially bent out of the plane of the clamping leg 6, with the free end of the actuating section 17 pointing in the direction of the attachment leg 7. The actuating bar 18 of the actuating element 12 is led laterally past the side edge of the clamping leg 6 to the actuating section 17 in order to exert an actuating force on it with its free end surface. The free end surface can be curved, as shown, e.g., have a semicircular cross-sectional contour to slide off at the actuating section 17.

The actuating section 17 can be aligned at an obtuse angle in the end clamping position shown, without the electrical conductor clamped on, as shown. The obtuse angle can, for example, be aligned in the range of about 100 to 140° and preferably from 120°±10° to the displacement axis V of the actuating element 12, as shown. Thus, an inclined surface is achieved relative to the curved front surface of the actuating bar 18 that allows for sliding. A force is induced on this inclined surface by the inclined surface, which shifts to a smaller angle, preferably an acute angle, for example, when actuated, in a force direction which causes the clamping leg 6 to open efficiently towards the attachment leg 7.

It is also clear that the actuating element 12 has a widened actuating head 31, from which the actuating element 18 protrudes towards the busbar 5. It is advantageous if 4 actuating bars 18 protrude on both sides of the clamping spring and actuate one actuating section 17 each. In this example, there are 6 actuating sections 17 protruding in opposite directions from the opposite side edges of the clamping leg 6 on both sides of the clamping leg 6.

The busbar 5 may be designed in such a way that a conductor feed-through opening 10 is incorporated on a cover plate 32 and a side wall 33 protrudes in the opposite direction to the resilient bend 8 on at least one side. This allows for a rigid design of the busbar 5 and a large conductive cross-section to increase the current-carrying capacity and reduce the conductive resistance.

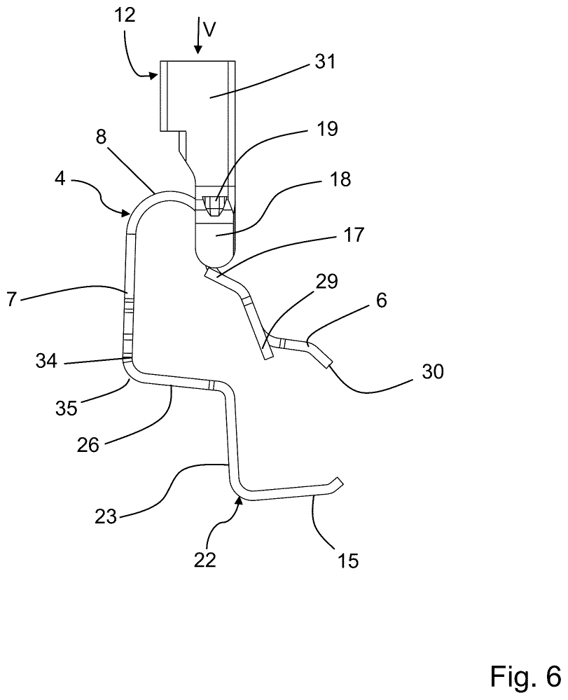

FIG. 6 shows a side view of the clamping spring 4 with actuating element 12 in the unlatched clamping position.

It becomes clear that in an area between the actuating section 17 and the free end of the clamping leg 6, where the clamping edge 30 is present, a latching tab 29 protrudes toward the triggering section 15. For this purpose, the clamping leg 6 can, for example, be bent out of a plane of the clamping leg 6 that is continued straight with the latching tab 29, pointing away from the attachment leg 7.

The attachment leg 7 may have laterally protruding bearing sections 34 adjacent to the bend available in the transition to the retaining arm 26, so that the attachment leg 7 in the area of the bearing sections 34 can be wider than in the adjoining section of the clamping spring 4, which is immersed in the conductor insertion opening 10, in particular the area with the bend to the retaining arm 26. This allows for the attachment leg 7 to be supported on the edge bars laterally limiting the conductor insertion opening 10.

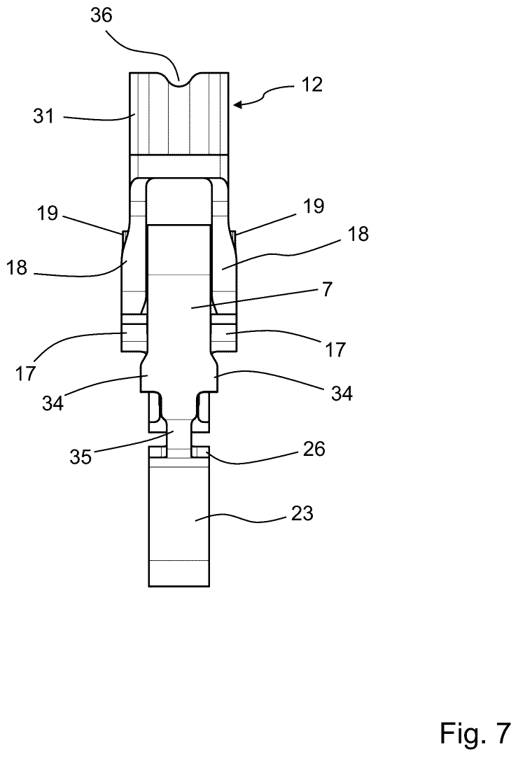

FIG. 7 shows a rear view of the clamping spring 4 with the actuating element 12 in the unlatched clamping position.

It becomes clear that the actuating element 12 has an actuating head 31, from which two actuating bars 18 protrude at a distance from each other and parallel to each other. The actuating bars 18 preferably protrude from the actuating head 31 at the lateral edge areas thereof. These are arranged next to the clamping spring 4 in such a way that they accommodate the clamping spring 4 between them. The actuating bars 18 are positioned laterally next to the side edges of a section of the clamping leg 6 and, if necessary, also a section of the resilient bend 8. The clamping leg 6 is not covered by the actuating element 12. The actuating sections 17 protrude on both sides of the clamping leg 6, which are impinged upon by the curved free end faces of the actuating bars 18.

The actuating bars 18 may be wider or thicker outwards, i.e., in the direction pointing laterally from the clamping leg 6 in the area between the free end and the stop contour 19, than the section extending from the stop contour 19 to the actuating head 31. This creates a ledge protruding from the adjacent plane, which forms a stop contour 19 securing the actuating element 12 on the insulating material housing 2.

It is also clear that the attachment leg 7 is designed wider, at least before the transition to the retaining arm 26, in order to form a bearing section 34 to support the clamping spring 4 on the busbar 5. The transition to the retaining arm 26 is made with a narrower, spring-elastic bend 35.

A tool holding contour 36 may be present on the free end face of the actuating head 31. As shown, this can be designed as a depression or a trough. For example, a slit-shaped or cross-slit-shaped depression is conceivable.

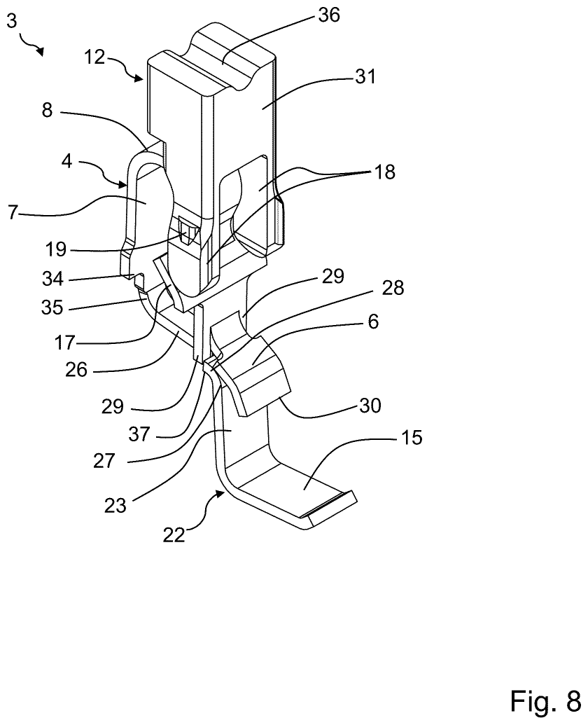

FIG. 8 shows a perspective front view of the clamping spring 4 with actuating element 12 in the latched hold-open position.

The latching tabs 29, which extend on both sides of the clamping leg 6 to the retaining arm 26, are immersed in a lateral free space of the retaining arm 26, which is thus located between the pair of latching tabs 29 in the latched hold-open position. The retaining arm 26 widens in the area of the bend 27, so that at the transitions on both sides, there is a front edge 37 for widening, which forms the latching contour 28. The free end areas of the latching tabs 29 impinge upon the respective front edge 37 (=latching contour 28). The clamping leg 6 presses against the front edges 37 by the force of the clamping spring 4, so that the clamping leg 6 is latched on the retaining arm 26 in the hold-open position.

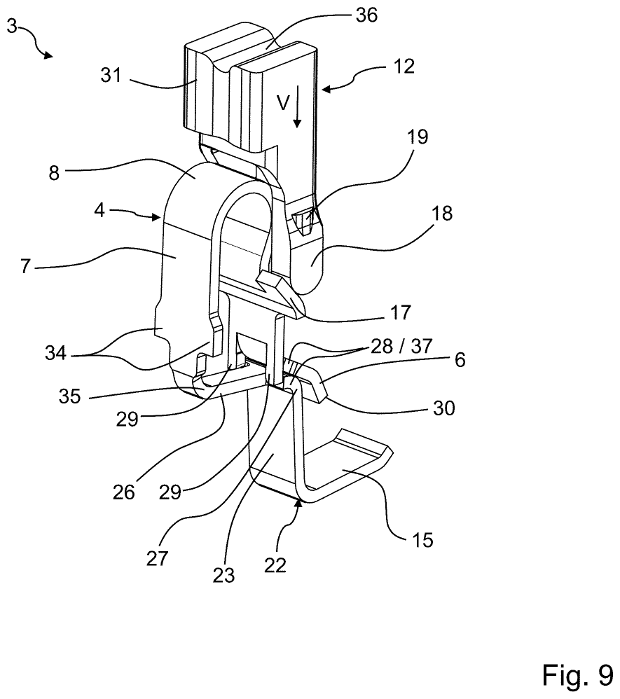

FIG. 9 shows a perspective rear view of the clamping spring 4 with the actuating element 12 in the latched hold-open position.

It can be seen that the actuating bars 18 are routed laterally along a section of the resilient bend 8 in the transition to the clamping leg 6 or laterally past the clamping leg 6 to the actuating sections 17 flared and protruding laterally from the clamping leg 6. Due to the curved end face of the actuating bars 18 and the actuating sections 17 flared at an angle for this purpose, an actuating force of the actuating element 12 acting in the displacement direction V is exerted on the clamping leg 6 in an opening force acting obliquely thereto with a force component in the direction of the attachment leg 7, which displaces said attachment leg into the illustrated hold-open position towards the attachment leg 7.

It can also be seen that the clamping leg 6 has latching tabs 29 spaced from each other from the area of the actuating sections 17, which preferably extend further towards the free end in a straight direction. The retaining arm 26 dips between the pair of latching tabs 29 in the latched hold-open position. The retaining arm 26 widens in the area of a bend 27 so that front edges 37 are formed, which act as latching edges or a latching contour 28 for the latching tabs 29.

The retaining arm 26 is bent from the attachment leg 7 at a bend 35. In the area of the latching contour 28 there is another bend 27 in which the triggering piece 22 joins the retaining arm with a vertical section 23. The vertical section 23 transitions into a horizontal triggering section 15 with a bend. The retaining arm 26 and the triggering section 15 are both essentially horizontal and approximately parallel to each other, wherein plane parallelism is not important here.

In this respect, the connecting section 23 extends essentially parallel to the displacement direction and is vertically aligned in this sense. In this respect, the retaining arm 26 and the triggering section 15 are aligned approximately horizontally, i.e., at an angle of about 90° with a tolerance of, e.g., ±10°.

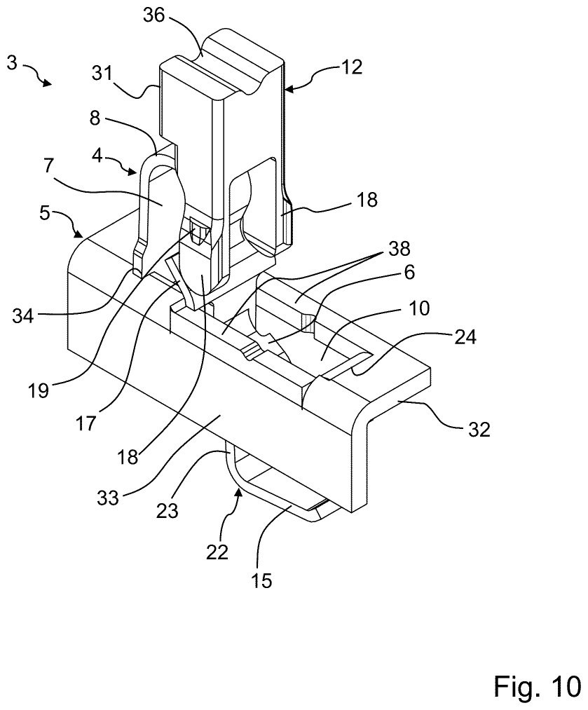

FIG. 10 shows a perspective front view of the spring force clamping connection 3 with actuating element 12 in the latched hold-open position.

It can be seen that the busbar 5 has a cover plate 32 into which a conductor feed-through opening 10 is inserted, leaving edge pieces 38. On one side, a side wall 33 is bent away from the cover plate 32, the upper edge of which forms an edge piece 38.

The clamping spring 4 dips into the conductor feed-through opening 10 with its attachment leg 7 and clamping leg 6. The attachment leg 7 with its bearing sections 34 (material flaps) protruding from the sides is supported on the cover plate 32 of the busbar 5.

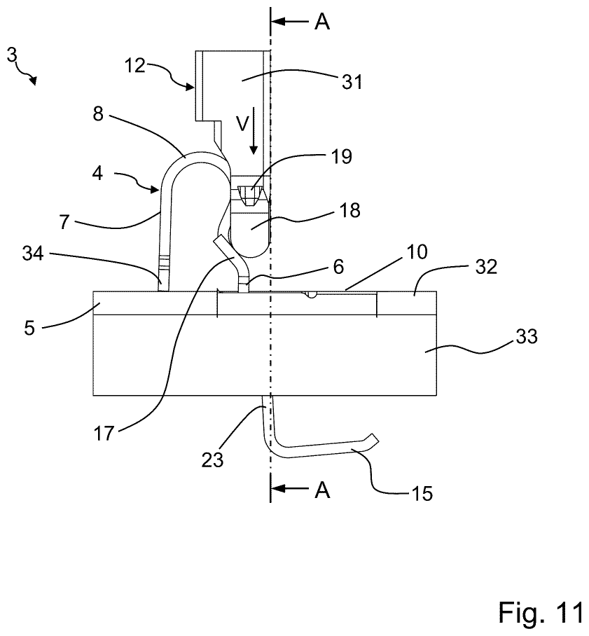

FIG. 11 shows a side view of the spring force clamping connection 3 with actuating element 12 in the latched hold-open position and the cutting line A-A.

It can be seen that the actuating sections 17, which protrude laterally from the clamping leg 6, are now at an acute angle to the displacement direction V of the actuating element 12. The angle in the hold-open position is preferably in the range of about 10° to 70°. For example, the angle can be approximately 40°±20°, as shown.

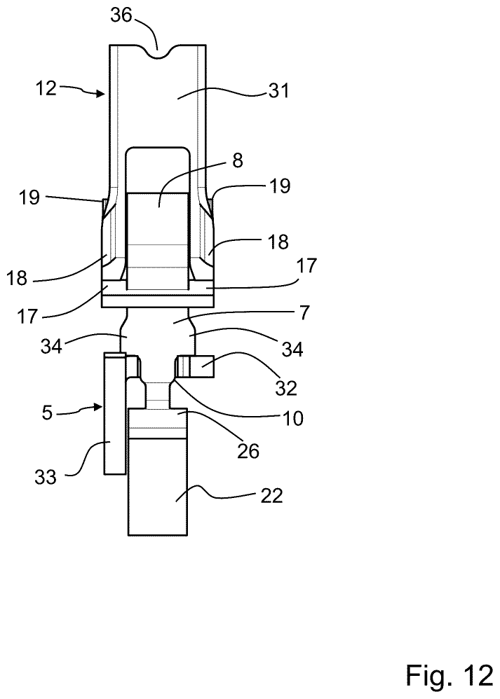

FIG. 12 shows a front view of the clamping spring 4 with actuating element 12 and busbar 5 in section A-A in the latched hold-open position.

It can be seen that the attachment leg 7 with its bearing sections 34 protruding from the sides are supported on the cover plate 32 of the busbar 5. It is also clear that the attachment leg 7 with a section adjoining the bearing sections 34 is immersed in the conductor feed-through opening 10 of the busbar 5 and is supported there on an end wall 25, which limits a narrow side of the conductor feed-through opening 10.

The clamping spring 4 is enclosed on both sides by the actuating bars 18, wherein the clamping leg 6 remains free and is not covered by the actuating element 12.

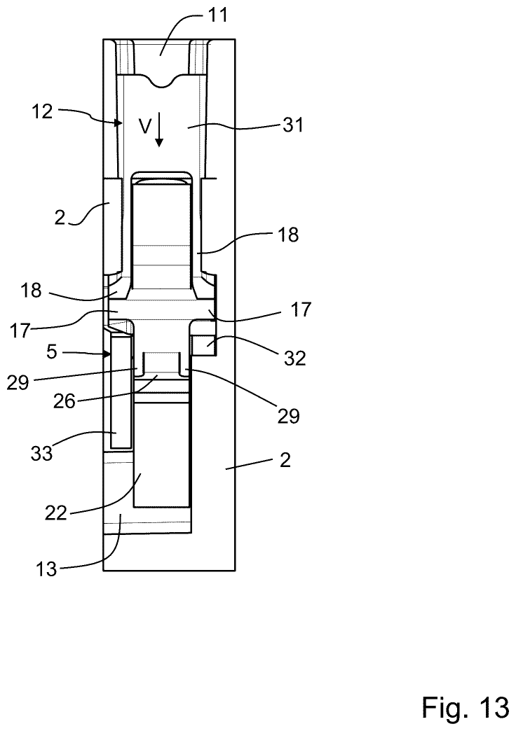

FIG. 13 shows a front view of the spring force clamping connection 3 with actuating element 12 in section A-A in the latched hold-open position.

It becomes clear that the actuating bars 18 are mounted in a guide groove in the insulating material housing 2 in the displacement direction V in a linear manner and are supported in the hold-open position on a corresponding actuating section 17 each.

The latching tabs 29, which protrude from the clamping leg on both sides, extend towards the retaining arm 26 and accommodate the retaining arm 26 between them in the hold-open position.

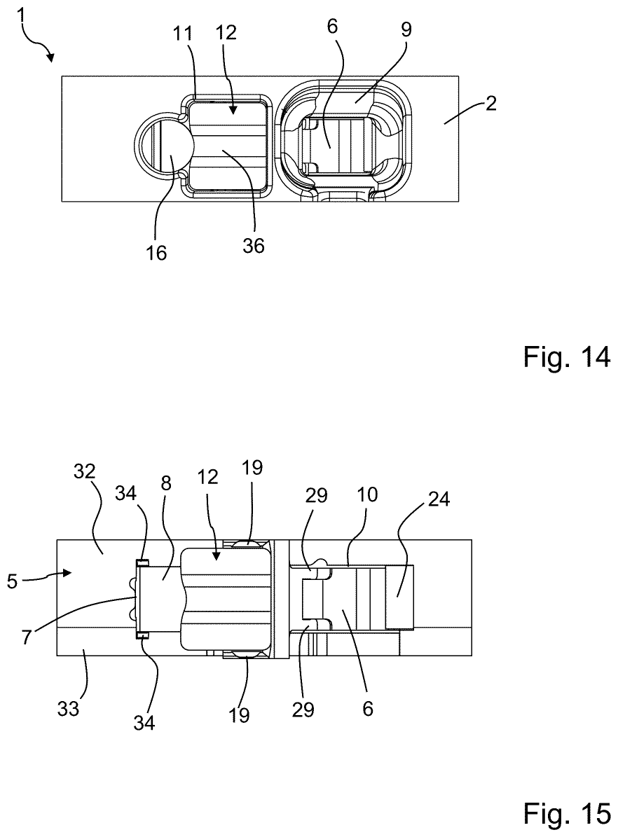

FIG. 14 shows a plan view of the conductor terminal 1. It can be seen that the test opening 16, the actuation channel 11 and the conductor insertion channel 9 are arranged next to each other on the top of the insulating material housing 2. The actuation channel 11 may be separated from the conductor insertion channel 9 by a partition wall.

The actuating element 12 is arranged in the actuation channel 11 and delimits the test opening 16 with a side wall, which is molded as a semicircular contour in the form of a concave wall surface on a side wall section of the actuation channel 11. This side wall section is spaced from the conductor insertion channel 9 and faces the conductor insertion channel 9.

FIG. 15 shows a top view of the spring force clamping connection 3 with actuating element 12. It can be seen that the actuating element 12 partially covers the resilient bend 8 and is thus located above a part of the resilient bend 8 in the transition from clamping leg 6 to resilient bend 8 with its widened actuating head 31 in the displacement direction V.

The actuating element 12 may have a metal insert for reinforcement, especially in the area of the actuating bars 18. The actuating sections 17 on the clamping leg 6 point “backwards”, so to speak, with their free end in the direction of the attachment leg 7.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
an insulating material housing;
a spring force clamping connection to connect an electrical conductor in the insulating material housing;
an actuating element; and
an actuating section,
wherein the spring force clamping connection has a busbar and a clamping spring,
wherein the clamping spring comprises a clamping leg having a clamping edge to clamp an electrical conductor to a contact section of the busbar, an attachment leg, which is in contact with the busbar and supports the clamping spring on the busbar, and a resilient bend, which connects the attachment leg with the clamping leg,
wherein the insulating material housing has a conductor insertion channel leading to the contact section of the busbar and an actuating channel,
wherein the actuating element is movably mounted in the actuating channel and is set up to exert force on the clamping leg in order to displace the clamping leg against the force of the clamping spring towards the attachment leg into a hold-open position, and
wherein the actuating section protrudes laterally from the clamping leg and the actuating element extends past a side edge of the clamping leg to the actuating section and is adapted to exert a force on the actuating section.

2. The conductor terminal according to claim 1, wherein the actuating element has an actuating head and two actuating bars protruding at a distance from each other from the actuating head, wherein actuating sections protrude from the clamping leg on both sides of opposite side edges of the clamping leg, and wherein the actuating bars each extend past one side edge of the clamping leg to the corresponding actuating section.

3. The conductor terminal according to claim 1, wherein the actuating element has a stop contour, wherein the insulating material housing and/or the clamping spring has a counter-stop contour, and wherein the stop contour and the counter-stop contour form a stop securing the actuating element in the actuation channel.

4. The conductor terminal according to claim 1, wherein a retaining arm is connected to the attachment leg, which, in a hold-open position, has a latching contour to latch the clamping leg, which is deflected towards the attachment leg against the spring force of the clamping spring.

5. The conductor terminal according to claim 4, wherein the retaining arm is spring-elastic in the region of the latching contour.

6. The conductor terminal according to claim 4, wherein the latching contour is formed by a retaining flap protruding from the retaining arm or a front edge on the retaining arm.

7. The conductor terminal according to claim 6, wherein the retaining arm adjacent to the latching contour is bent pointing away from the clamping leg and the retaining arm is tapered from the bend to the attachment leg, wherein a front edge at the transition of the side edge of the retaining arm to the laterally protruding widened section of the bend forms the latching contour.

8. The conductor terminal according to claim 7, wherein on both sides of opposite side edges of the tapered section of the retaining arm, widened sections of the bend protrude laterally on the retaining arm and form a latching contour with their front edges.

9. The conductor terminal according to claim 4, wherein a latching tab protrudes from the clamping leg towards the retaining arm and is set up to be latched in the latching contour in the hold-open position of the clamping leg.

10. The conductor terminal according to claim 4, wherein, on the side facing away from the attachment leg, a triggering piece is connected to the retaining arm, which extends with a triggering section into the alignment of the conductor insertion channel and is designed to be deflected by an electrical conductor inserted into the conductor insertion channel for clamping to the busbar, and to release the latching contour for releasing the clamping leg that is latched in the hold-open position.

11. The conductor terminal according to claim 10, wherein the triggering piece forms a tapering free end of the clamping spring.

12. The conductor terminal according to claim 10, wherein the insulating material housing has a run-on slope for guiding an electrical conductor to the triggering section, wherein the run-on slope is arranged between the alignment of the conductor insertion channel and a connecting section of the triggering arm extending from the retaining arm to the triggering section.

13. The conductor terminal according to claim 1, wherein the busbar has a conductor feed-through opening, and wherein the clamping spring protrudes with its attachment leg and clamping leg into the conductor feed-through opening.

14. The conductor terminal according to claim 13, wherein the clamping spring with its attachment leg is supported on an end wall limiting the conductor feed-through opening.

15. The conductor terminal according to claim 13, wherein the attachment leg with its section protruding into the conductor feed-through opening is tapered and is supported on the busbar with bearing sections, which form the transition of the taper to the wider section extending towards the resilient bend and protrude laterally from the tapered section.

16. The conductor terminal according to claim 13, wherein a retaining arm is connected to the attachment leg, wherein the retaining arm is bent away from the clamping leg below the busbar on an underside facing away from an upper side of the busbar facing the resilient bend of the clamping spring.

17. The conductor terminal according to claim 1, wherein the at least one actuating section points with its free end towards the attachment leg.
